(19) United States
(12) Patent Application Publication
(10) Pub. No.: US 2020/0353428 A1
(43) Pub. Date: Nov. 12, 2020

(54) EMULSIFICATION MODULE FOR USE WITH A FOOD PROCESSOR

(71) Applicant: Lifetime Brands, Inc., Garden City, NY (US)

(72) Inventor: Jason Liang, Seattle, WA (US)

(21) Appl. No.: 16/407,649

(22) Filed: May 9, 2019

(51) Int. Cl. B01F 3/08; B01F 7/00; B01F 7/20; B01F 15/02

(52) U.S. Cl. CPC B01F 3/0853; B01F 3/0807; B01F 7/0025; B01F 2215/0014; B01F 7/00641; B01F 7/20; B01F 15/0233; B01F 7/00566

(57) ABSTRACT

An emulsification module for a food processor enables the careful and methodical introduction of ingredients (e.g., oil) into the main container, thus allowing the same to emulsify the ingredients. The emulsification module includes a container configured to be removably connected to, and rotate with, the rotating blade assembly, and one or more oil dispensers positioned on a side surface thereof. The centrifugal forces generated by the rotation of the blade assembly causes the oil in the container to be propelled up the inside walls of the same and come out of the oil dispensers and drizzle down the side walls of the main container. Whisk members positioned on the bottom of the module (between the blades of the blade assembly) assist in mixing of the drizzled oil with the ingredients to achieve the desired emulsification.

### BACKGROUND

### Technical Field

The present invention relates to food processors. More particularly, it relates to an emulsification module for use with food processors.

### Description of the Prior Art

The use of food processors for preparing food for serving and/or cooking is commonplace in today's kitchens. These food processors can be electrically or manually operated. Electric processors generally have variable speeds, while manual processors require the user to hand operate the same in a somewhat consistent manner to achieve a desired result. An example of a manually operated food processor can be seen by U.S. Pat. No. 7,264,189, the entire contents of which are incorporated herein by reference.

An interesting challenge is faced when attempting to use these types of food processors to make foods that require emulsification of the ingredients, like, for example, mayonnaise. Those of skill in the art will appreciate that in order to make mayonnaise, the process of emulsification of the ingredients requires careful and methodical introduction of the oil into the main container. One cannot simply put all the ingredients into the container and spin it, the oil must be drizzled in slowly in order to emulsify the ingredients properly. Current food processing equipment does not allow for this, and therefore are unsuitable for such application.

The present invention overcomes the shortfalls of the prior art by providing a emulsification module that can be used with these types of food processors.

### SUMMARY

According to an implementation, the emulsification module for a food process includes a container configured to fit within a main container of the food processor and rotate with a blade assembly selectively driven by a drive mechanism releasably attached to the main container. The container includes one or more oil dispensers; and at least one whisk element positioned on a bottom of the container.

According to another implementation the food processor includes a drive mechanism positioned on a main container and a blade assembly connected to the drive mechanism. The emulsification module includes a container configured to rotate with the blade assembly and having one or more oil dispensers, and at least one whisk element positioned on a bottom of the container.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is an isometric view of a hand-held hand-powered food processor according to the prior art;

FIG. 2 is an axial cross section of the food processor shown in FIG. 1;

FIG. 3 is an exploded view of the food processor of the prior art;

FIG. 4 is an elevational view of an example of manually operated food processor configured to accommodate the mayonnaise maker module according to an embodiment of the invention;

FIG. 5 is an exploded perspective view of the food processor of FIG. 1 with the mayonnaise maker according to an embodiment of the invention;

FIG. 6 is a perspective view of the mayonnaise maker module according to an embodiment of the invention;

FIG. 7 is an exploded perspective view of the mayonnaise maker module according to an embodiment of the invention.

FIG. 8A is a front view of the food processor with the mayonnaise maker module and the outer container removed, according to an embodiment of the invention;

FIG. 8B is an enlarged view of an exemplary blade assembly onto which the mayonnaise maker module of the present invention can be positioned, according to an embodiment;

FIG. 8C is another view of the blade assembly of FIG. 8B; and

FIG. 9 is a cross sectional view of the food processor of FIG. 4 take along line A-A, according to an embodiment of the invention.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with the technology have not been shown or described in detail to avoid unnecessarily obscuring descriptions of the implementations.

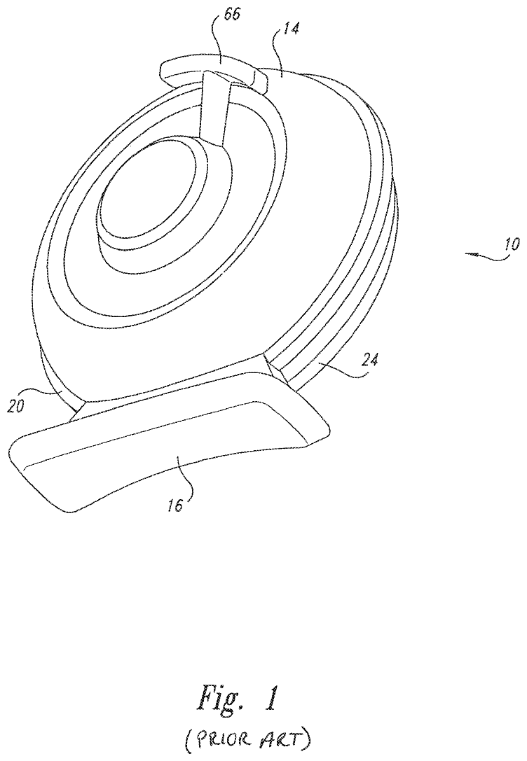

For purposes of background and understanding, FIGS. 1-3, and corresponding description is from U.S. Pat. No 7,264,189 and shows an example of a hand operated food processor, to which the present invention is applicable.

Referring to FIGS. 1-3, a hand-held hand-powered food processor 10, includes an axial end cup or food holder 12 fitted in an axial end housing 14.

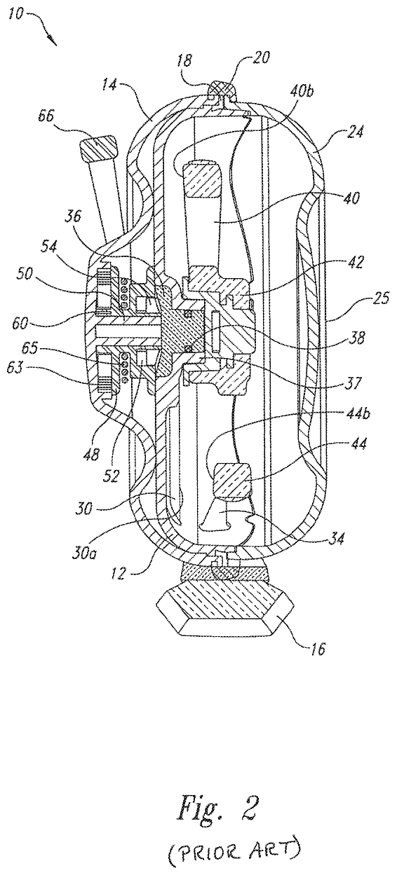

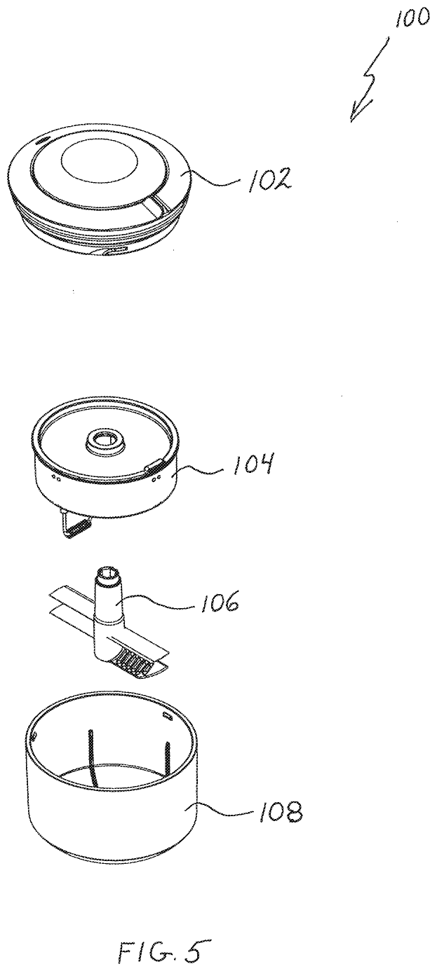

A palm grip or table support member 16 is attached to the end housing 14. The support member is made of rubber and can either be held in the palm of the hand when the processor is being held only in the hands or can be rested on a table or counter when the processor is used in the upright position as shown in FIG. 2. The end housing is formed with a gasket 18 and a locking collar 20. The food holder 12, gasket and locking collar are all bonded together. The locking collar has locking slots 22 that mesh with ribs 23 on a cover 24. The cover is thus attached and sealed by inserting the locking ribs into the locking slots and giving a relative twist between the cover and the end housing in a well-known manner. The food holder has an end surface 28 and a sidewall 32. A long rib 30 is formed on the end surface. A small stop block 34 is attached to the sidewall. When the processor is held with the support member down as in FIGS. 2 and 5, it can be seen that the rib 30 and stop block 34 are both positioned near the vertical center line of the cup. This allows food in the processor to accumulate by gravity over the stop block and adjacent the long rib to enhance contact between the arm 40 (described below) and the food in the cup 12. The food is thus subjected to more shearing action between the arm when the arm is a chopper (as described below) or more peeling action when the arm is a peeling arm (also described below). The preferred position for use of the processor is thus as shown in FIG. 2 but the processor can also be held in other positions. A drive shaft 36 extends through a collar 37 fixed to the end surface of the food holder and is sealed with an o-ring 38. The drive shaft has a radial right angle notch 43. The hub has a key 45 that fits into the notch and is thus drivingly but removably connected to the drive shaft.

The cover 24 also has a uniform outer periphery 25 which serves as a base to support the cover on a table or counter top when the cover is removed from the food processor. In this manner chopped foods, peeled garlic, or blended liquid dressings can be deposited into the cover by removing the cover from an underside or bottom position on the processor. Thus, the contents of the processor will fall down into the cover which can then be removed and placed on the table or counter top for holding the contents of the processor.

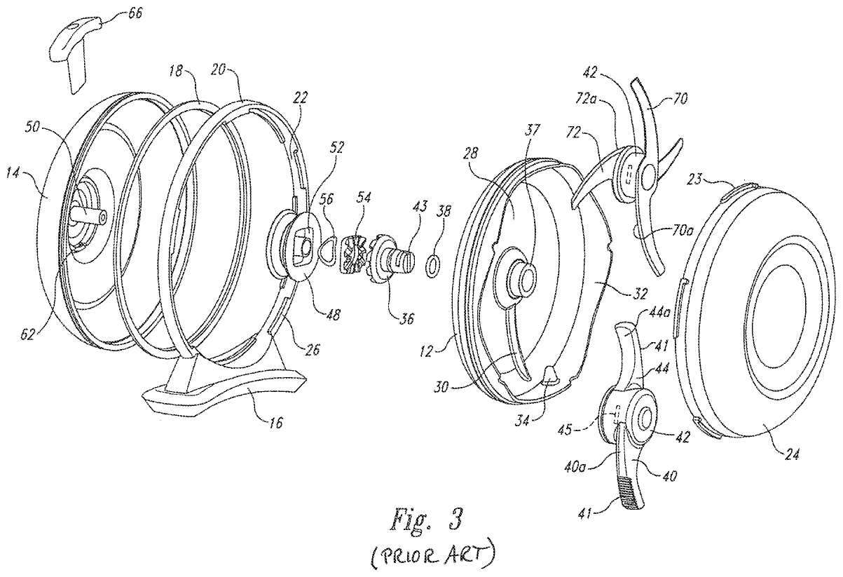

An arm 40 is attached to a hub 42. A second arm 44 axially spaced from the first arm is also attached to the hub. The first arm that lies closer to the widest part or center of the cup and cover is slightly longer than the second arm. The arms have ends 40a and 44a (FIG. 3) that are spaced closely from the stop block 34. The arms are generally convex on their forward surface in plan view and each has a forward facing roughened surface 41 in the direction of rotation of the arms. In FIG. 3, the roughed surface is transverse grooves but other roughed or textured surfaces can also be used. The elastomeric material itself can be of a sticky type. The purpose of the forward facing surfaces is to engage the skin of the food to be peeled, such as garlic cloves, and rub against the skin to dislodge it from the garlic clove. The stop block 34 serves to stop the garlic from freely spinning around in the cup. The long rib 30 also tends to hold the garlic and allow the arms to rub against the garlic so held by the rib.

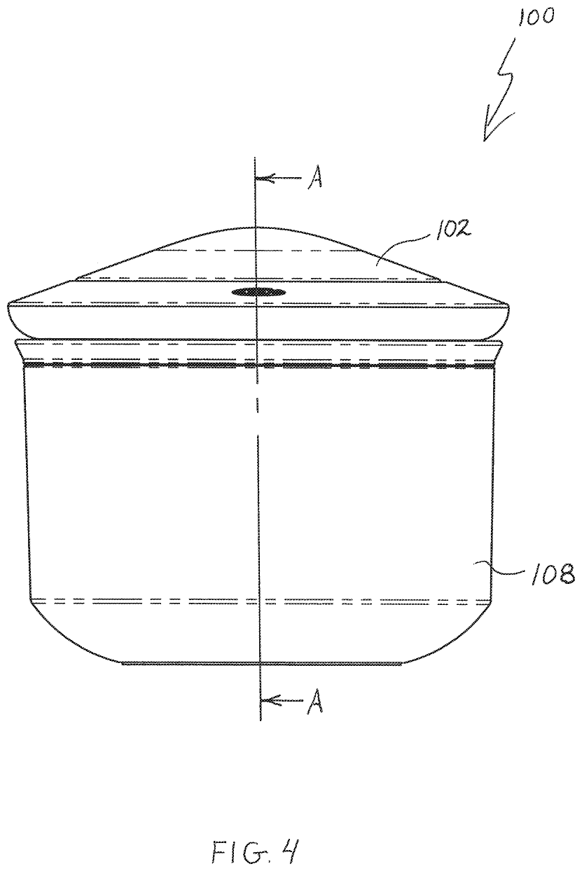

The action of the arms or only one arm, such as arm 44, can successfully peel garlic but the use of two arms provides improved and more effective peeling action. The long rib 30 is also not essential, as shown in FIG. 4, but the use of this rib also speeds up the peeling action. When a rib 30 is used the gap between the top of the rib 30a and the confronting surfaces 40b or 44b of the arms 40 and 44 is preferably between 0.050 and 0.150 inches. Thus, the preferred peeler is to have two arms 40 and 44, the long rib 30, and the stop block 34 but is should be understood that the invention encompasses the use of only one arm and without a long rib on the end surface of the food holder. It is also believed that even the stop block can be eliminated if the arms are used in an electrically powered food processor. When the power is manual, the shorter period for peeling is more important than if the power to rotate the drive shaft is an electric motor that can run for a longer period of time. The elastomeric arms are made of a flexible elastomeric material having a durometer of between Shore A 60 and Shore A 100 and preferably a durometer of between Shore A 80 and Shore A 82.

The propulsion for the drive shaft is a unique manually powered pull cord motor having a pulley 48 rotatably mounted on a post 50. The pulley has a square recess 52 in which is fitted a toothed ratchet wheel 54. The ratchet wheel is biased outwardly (to the right in FIG. 3) by a disc spring 56. The teeth of the ratchet wheel mesh in a driving direction with mating teeth in the drive shaft 36. But reverse rotation of the pulley allows the teeth of the ratchet wheel to slide past the teeth of the drive shaft. The pulley has a slot 60, the housing has a slot 62, and a coiled strip spring 63 has its ends fitted in the slots, in a well know manner, and provides the return rotation to the pulley. Thus, the unidirectional rotational motion of the drive shaft is accomplished in the hand-powered version of the food processor by a pull cord 65 having several wraps around the pulley. The pull cord has a handle 66. The advantage of this pull cord type of rotational drive or motor is that the elastomeric arms are run at a high torque and at a high velocity (over 500 rpm) for several revolutions (about 5 or 6) from each pull of the handle 66. These rotations are for a relatively long rotational period. The arms have little mass and thus will stop prematurely when engaging the food in the processor unless the pull cord type of motor applies the high torque and long duration of rotation.

As shown in the following FIGS. 4, and 8-9, the drive mechanism 120 is analogous to the pull cord type of rotational drive described above.

Referring to FIGS. 4 and 5, there is shown a food processor 100 having a drive mechanism 102 positioned on top of the main container 108. An emulsification module 104 is configured to be removably positioned over the blade assembly 106 and rotate therewith, as the blade assembly is driven by the drive mechanism 102. The drive mechanism 102 is a hand or manually driven device and is similar in operation to that shown and described above with respect to the example shown in FIGS. 1-3. Those of skill in the art will appreciate that the drive mechanisms shown here are for exemplary purposes, with the understanding that different drive mechanisms (electric or manual) could be implemented without departing from the intended scope of the present disclosure.

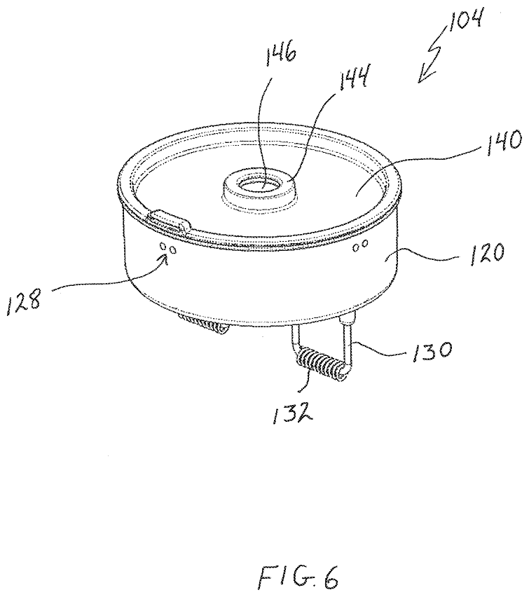

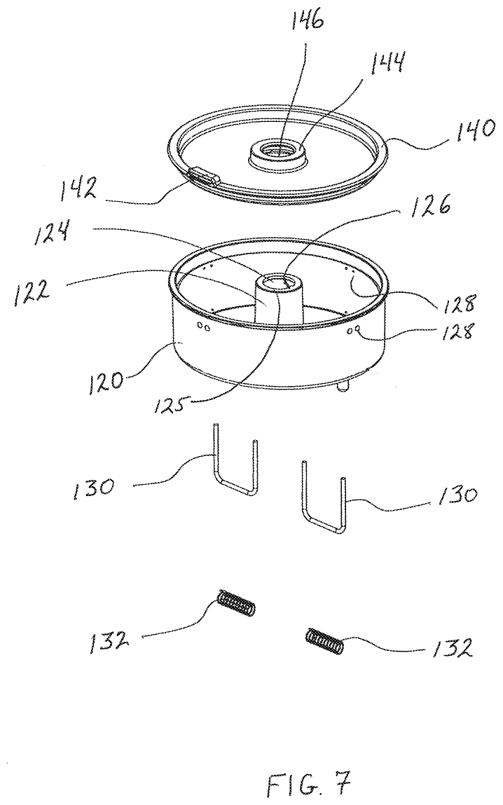

Referring to FIGS. 5-7, it can be seen that that the emulsification module 104 includes a somewhat donut shaped or toroidal container 120 having a hollow central post 122 with an upper hole 124 defined by an inwardly radially extending shelf 125 having a further inward radially extending detent 126 for receiving and positioning the module 104 on the post of the blade assembly 106 (discussed in more detail below). A cover 140 encloses the container 120 and can be snap fitted onto the container 120 or can include a releasable locking mechanism 142 positioned on a periphery thereof for securing the cover 140 to the container 120. The container 120 includes oil dispensing holes 128 positioned along the outer surface of the container. In the exemplary embodiment shown, there are four (4) sets of holes 128 positioned approximately at 90 degree intervals of the container 120, however different positioning of the same can be implemented as well. On the underside of the module 104, there are a pair of U-shaped whisk members 130 having whisking springs 132 positioned thereon.

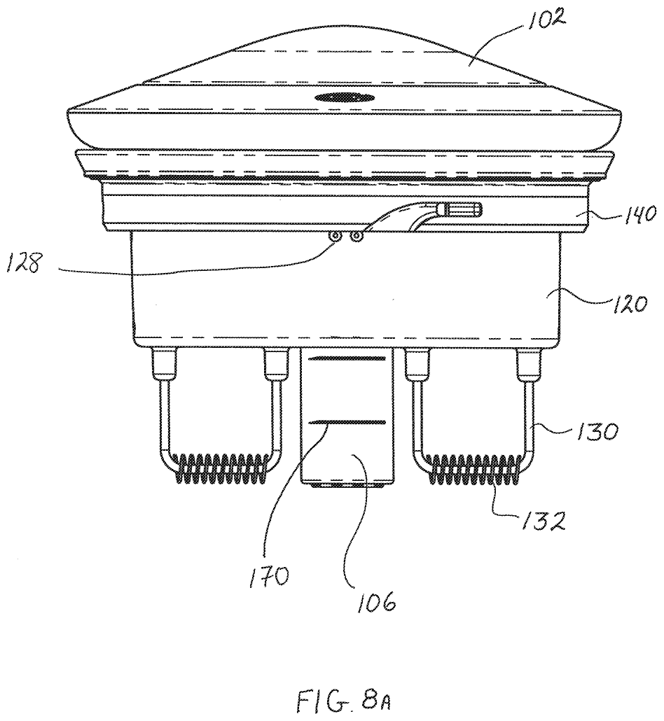

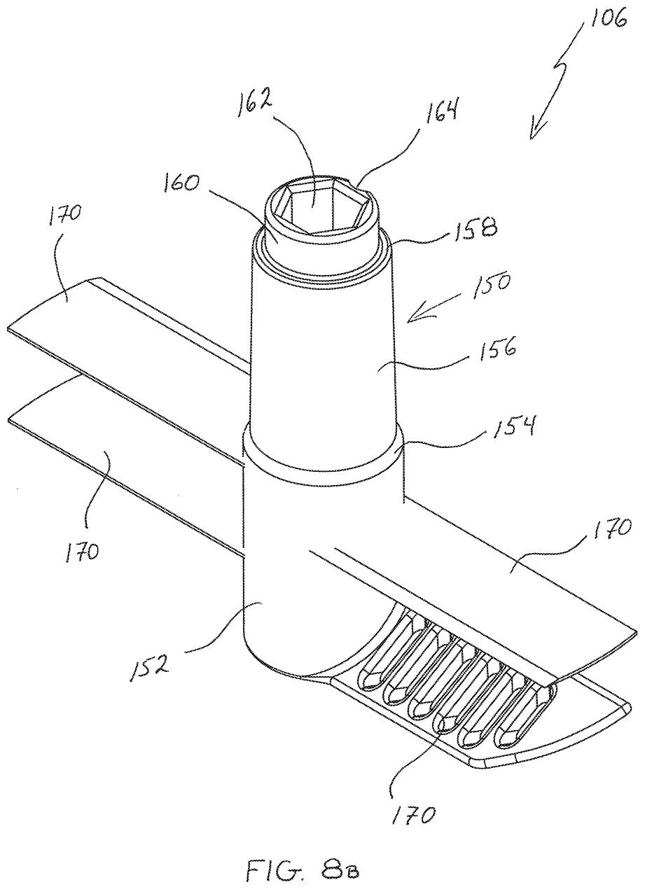

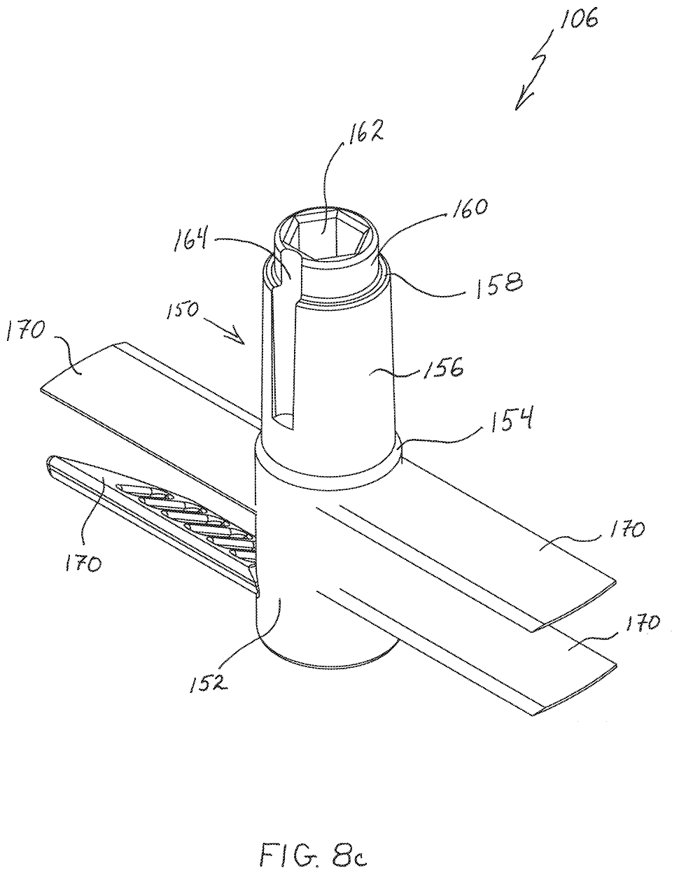

FIG. 8A shows the emulsification module 120 assembled with the drive mechanism 102 and blade assembly 106 and the outer container 108 removed from the same. As can be seen, the whisk members 130, 132 are positioned between the blades 170 of the blade assembly 106.

FIGS. 8B and 8C show an exemplary representation of the blade assembly 106 configured to accommodate the mayonnaise maker module 120. The blade assembly 106 includes a central post 150 having a generally frusto-conical shape including a lower portion 152 from which blades 170 radially extend outward, a mid or central portion 156, and an upper portion 160. The lower portion 152 is separated from the central portion 156 via a ledge 154, and the central portion 156 is separated from the upper portion 160 via a ledge 158. The upper portion 160 includes a keyed opening 162 and an exterior notch or keyway 164. The keyed opening 162 is configured to receive a complementarily shaped drive shaft from the drive mechanism 102, and thereby spin in response to actuation of the same. In the example shown, the keyed opening 162 is hexagonal in shape. Those of skill in the art will appreciate that other geometric shapes, or methods for receiving and securing a drive shaft of the drive mechanism 102 into the opening 162 such that the blade assembly 106 rotates therewith can also be implemented.

According to the exemplary embodiment, the base of the hollow central shaft 122 of the emulsification module 120 rests on the ledge 154 of the blade assembly 106. The blade assembly shaft 150 is sized to be inserted into the hollow shaft 122 of the module 120 such that the detent 126 in the upper shelf 125 engages the notch 164. The shelf 125 engages the ledge 158, and the emulsification module is now in position to be used.

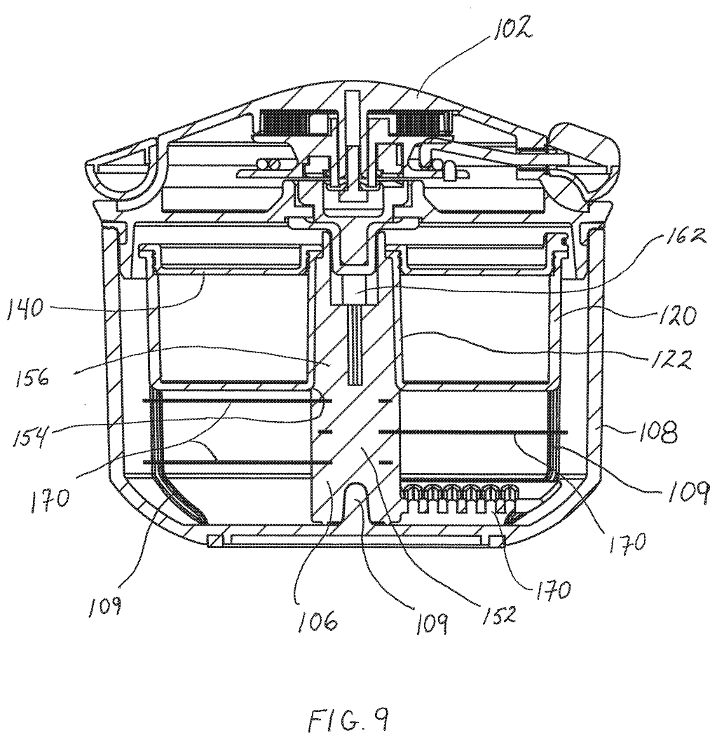

FIG. 9 shows a cross sectional view of the exemplary embodiment shown in FIG. 1. As shown, the blade assembly is rotatably positioned on a post 109 integrally formed within the base of the container 108. The container 120 of the mayo maker module 104 is seated on the central portion 156 of the post as described above, and the drive mechanism 102 having a drive shaft 103 is positioned on the container 108 such that the drive shaft 103 engages the keyed opening 162 of the blade assembly passing through the openings124 and 146 of the hollow shaft 122 and cover 140, respectively.

During operation of a manually operated food processor, the user would pull on the handle (or push down on an actuator) to create a spinning motion that drives the blade assembly 106. The main container 108 includes ribs 109 that keep the food or liquids from freely spinning around the inside without being cut by the blades 170.

According to the present invention, when the emulsification module 104 is in place to make, for example mayonnaise, the user will fill the container 120 with the oil needed. When the drive mechanism is actuated, the container 120 spins and the oil is propelled up the inner walls of the container and ultimately seeps out of the holes 128 in the container (due to centrifugal forces created therein from rotation). This causes the oil to slowly be trickled out onto the egg yolks and other ingredients already in the bottom of the main container 108 while the same is spinning. The whisk elements 130, 132 and the blades 170 stir, blend and emulsify everything at the bottom of the container.

As will be appreciated by those of skill in the art, the manually driven drive mechanism pulses when actuated repeatedly (e.g., by repeatedly pulling on a ratcheted cord, or repeatedly pressing down on an actuator). Thus, on each pull of the cord, or actuation of the drive mechanism, a little bit more oil makes it out of the drizzle holes 128 and down the walls of the main container 108 into the mixing zone. The drive mechanism is continuously actuated until the mayonnaise thickens up and all the oil has been drizzled out of the oil container 120.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. An emulsification module for a food processor, the food processor having a drive mechanism positioned on a main container and a blade assembly connected to the drive mechanism and which rotates in response to actuation of the drive mechanism, the emulsification module comprising:
a container configured to rotate with the blade assembly and having one or more oil dispensers; and
at least one whisk element positioned on a bottom of the container.

2. The emulsification module according to claim 1, wherein the container comprises a toroid shape configured to removably fit onto a shaft of the blade assembly.

3. The emulsification module according to claim 1, wherein the one or more oil dispensers comprises one or more holes in a peripheral side of the container.

4. The emulsification module according to claim 1, wherein said at least one whisk element comprises a U-shaped member attached to a bottom of the container via the legs of the U-shaped member and a spring around a base of the U-shaped member.

5. The emulsification module according to claim 3, wherein the one or more holes are positioned on the side of the container such that oil is dispensed when the container is rotated with the blade assembly due to centrifugal forces generated by the rotation.

6. The emulsification module according to claim 2, wherein the at least one whisk element comprises two whisk elements, each being disposed on opposing sides of the bottom of the container such that when the container is positioned on the shaft of the blade assembly, the two whisk elements are positioned between opposing blades of the blade assembly.

7. An emulsification module for a food processor, comprising:
a container configured to fit within a main container of the food processor and rotate with a blade assembly selectively driven by a drive mechanism releasably attached to the main container, the container having one or more oil dispensers; and
at least one whisk element positioned on a bottom of the container.

8. The emulsification module according to claim 7, wherein the one or more oil dispensers comprises one or more holes in a peripheral side of the container.

9. The emulsification module according to claim 7, wherein said at least one whisk element comprises a U-shaped member attached to a bottom of the container via the legs of the U-shaped member and a spring around a base of the U-shaped member.

10. The emulsification module according to claim 8, wherein the one or more holes are positioned on the peripheral side of the container such that oil is dispensed from the same in response to centrifugal forces generated when the container is rotated.
